(19) United States
(12) Patent Application Publication
(10) Pub. No.: US 2002/0085383 A1
(43) Pub. Date: Jul. 4, 2002

(54) Disassembly-type lamp shade structure

(76) Inventor: Wen-Chang Wu, Chang Hua Hsien (TW)

Correspondence Address: DOUGHERTY & TROXELL, 5205 LEESBURG PIKE, SUITE 1404, FALLS CHURCH, VA, 22041, US

(21) Appl. No.: 09/752,739

(22) Filed: Jan. 3, 2001

(51) Int. Cl. F21V 1/16

(52) U.S. Cl. 362/450; 362/357

(57) ABSTRACT

A disassembly-type lamp shade structure of simple assembly and reduced physical dimensions comprised of a top ring situated at the uppermost end of a lamp shade, a bottom ring of larger circumference than the top ring, and frame members propped between the top ring and the bottom ring. The top ring has support rods extending from the center towards its circumference and, furthermore, the support rods each have at their extremities an upward bend to form an insertion hook that is fixed onto the circumference of the top ring. The bottom ring has respectively disposed at the support positions of the frame members sleeve mounts that provide for the insertion of the frame members, after which the upper horizontal curved rods of the frame members are situated against the insertion hooks at the extremities of the support rods and the lower horizontal curved rods are situated against the bottom ring, thereby positioning and limiting the movement of the frame members. At the area of confluence between the frame member upper horizontal curved rods and the support rods, the upper horizontal curved rods have formed by downward bending an indentation serving as a catch hook that secures the insertion hook, thereby fixing the position of the frame members. When packaged, the frame members must be first removed and laid flat such that lamp shade of the present invention occupies the smallest physical assembly space to facilitate ease of assembly and, furthermore, the resulting minimized storage area effectively reduces shipping costs.

### BACKGROUND OF THE INVENTION

1) Field of the Invention

The invention herein relates to a disassembly-type lamp shade structure in which the top ring has support rods extending from the center towards its circumference and, furthermore, the support rods each have at their extremities an upward bend to form an insertion hook that is fixed onto the circumference of the top ring; after the frame members are inserted into the bottom ring sleeve mounts, indentations serving as catch hooks formed by downward bending along the upper horizontal curved rods of the frame members at the area of confluence between the frame member horizontal curved rods secures the insertion hooks, thereby fixing the position of the frame members such that when packaged, the frame members must be first removed and laid flat so the lamp shade occupies the smallest physical assembly space to facilitate ease of assembly and, furthermore, the resulting minimized storage area effectively reduces shipping costs.

2) Description of the Prior Art

A conventional lamp shade 5, referring to FIG. 6, typically has its frame members permanently fixed between the top ring and the bottom ring to form a lamp shade structure; however, since its structure is imperfect, the numerous practical shortcomings that result include the following example.

Since the conventional lamp shape 5 is a structural entity of an unyielding shape, when it is packaged in a carton, the lamp shade 5 cannot be forcefully diminished in size and no reduction in large volume storage area is possible, which leads to a proportional increase in product shipping costs and results in greater overhead.

In view of the said shortcomings, the inventor of the invention herein conducted extensive research that culminated in the successful development of a disassembly-type lamp shade structure that entirely eliminates the drawbacks of the conventional product and, furthermore, is capable of significantly greater practicality.

### SUMMARY OF THE INVENTION

The primary objective of the invention herein is to provide a disassembly-type lamp shade structure comprised of a top ring, a bottom ring, and frame members propped between the top ring and the bottom ring, wherein the top ring has support rods extending from the center towards its circumference and, furthermore, the support rods each have at their extremities an upward bend to form an insertion hook that is fixed onto the circumference of the top ring; the said bottom ring has respectively disposed at the support positions of the frame members sleeve mounts that provide for the insertion of the frame members, after which the upper horizontal curved rods of the frame members are situated against the insertion hooks at the extremities of the support rods and the lower horizontal curved rods are situated against the bottom ring, thereby positioning and limiting the movement of the frame members; and, at the area of confluence between the frame member upper horizontal curved rods and the support rods, the upper horizontal curved rods have formed by downward bending an indentation serving as a catch hook that secures the insertion hook, thereby fixing the position of the frame members; when packaged, the frame members must be first removed and laid flat such that lamp shade of the present invention occupies the smallest physical assembly space to facilitate ease of assembly and, furthermore, the resulting minimized storage area effectively reduces shipping costs.

Another objective of the invention herein is to provide a disassembly-type lamp shade structure in which the bottom ring has respectively disposed at the support positions of the frame member sleeve mounts, the sleeve mounts each have projecting upward a keeper hole that provides for the fixed insertion of the frame members and, furthermore, after the frame member insert posts are slipped into the sleeve mounts, the sleeve mount keeper holes retain them by an integrated press-fit lock annulus; and furthermore, the two sides of the bottom ring annular rod-like body to which each sleeve mount is conjoined are punch flattened such that after punch flattening, the stop nubs thereby formed position and limit the movement of the sleeve mounts.

To enable the examination committee a further understanding of the present invention, the brief description of the drawings below are followed by the detailed description of the invention herein.

### BRIEF DESCRIPTION OF THE DRAWINGS

FIG. 1 is an exploded drawing of the invention herein.

FIG. 2 is an isometric drawing of assembled invention herein.

FIG. 2A is an orthographic drawing of the support section at the top ring and a frame member, as shown in a magnified view.

FIG. 3 is an isometric drawing of the invention herein in the folded state.

FIG. 4 is an isometric drawing of another embodiment of the invention herein.

FIG. 4A is an isometric drawing of the insertion section at the sleeve mount and a frame member, as shown in a magnified view.

FIG. 4B is a cross-sectional drawing of the sleeve mount and frame member assembly.

FIG. 5 is a cross-sectional drawing of the assembled lamp shade of the invention herein.

FIG. 5A is a cross-sectional drawing of the adhesion section, as shown in a partial magnified view.

FIG. 6 is an isometric drawing of a conventional lamp shade.

### DETAILED DESCRIPTION OF THE INVENTION

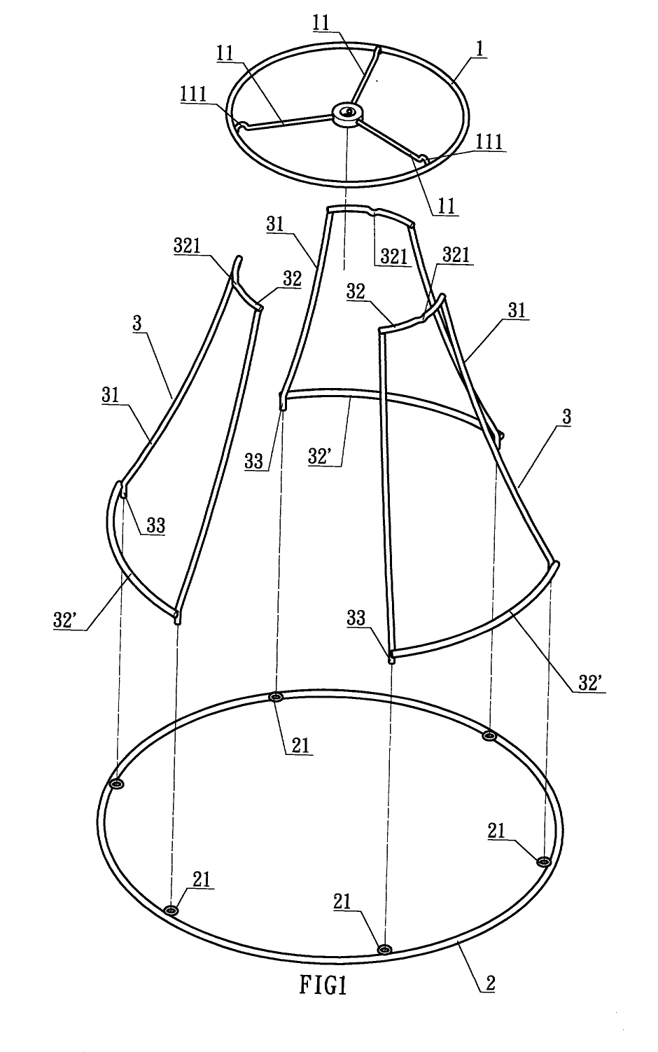

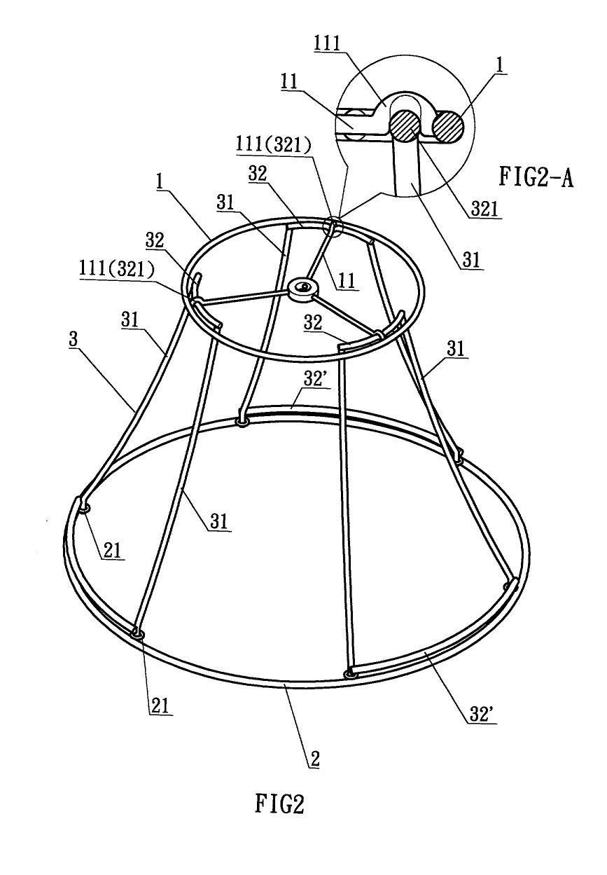

Referring to FIG. 1 and FIG. 2, the drawings of the structural arrangement of the present invention, the invention herein is comprised of a top ring 1 situated at the uppermost end of a lamp shade, a bottom ring 2 of larger circumference than the top ring 1, and frame members 3 propped between the top ring 1 and the bottom ring 2; of which:

The said top ring 1 is of annular metal construction and, furthermore, is placed against the columnar lamp pipe structure, with the top ring 1 having support rods 11 extending from the center towards its circumference and, furthermore, the support rods 11 each have at their extremities an upward bend to form an insertion hook 111 that is fixed onto the circumference of the top ring 1, thereby providing for the placement of the frame members 3 against it and the engaged positioning of the frame members 3.

The said bottom ring 2 has respectively disposed at the support positions of the frame members 3 sleeve mounts 21 that provide for the insertion of the frame members 3.

The said frame members 3 consist of left and right vertical curved rods 31 and coordinated upper and lower horizontal curved rods 32, with the degree of curvature of the upper horizontal rods 32 matching that of the top ring 1 and the degree of curvature of the lower horizontal rods 32 matching that of the bottom ring 2; at the area of confluence between the frame member 3 upper horizontal curved rods 32 and the support rods 11, the upper horizontal curved rods 32 have formed by downward bending an indentation serving as a catch hook 321 that secures the insertion hook 111, thereby fixing the position of the frame members 3; the frame member 3 bottom ends are bent so they meet with the bottom ring 2 in a perpendicular arrangement and, furthermore, the insert posts 33 thereby formed are capable of being slipped into the bottom ring 2 sleeve mounts 21 such that after the frame member 3 insert posts 33 are slipped into the sleeve mounts 21, the upper horizontal curved rods 32 are situated against the insertion hooks 111 at the extremities of the support rods II and the lower horizontal curved rods 32 are situated against the bottom ring 2, thereby positioning and limiting the movement of the frame members 3.

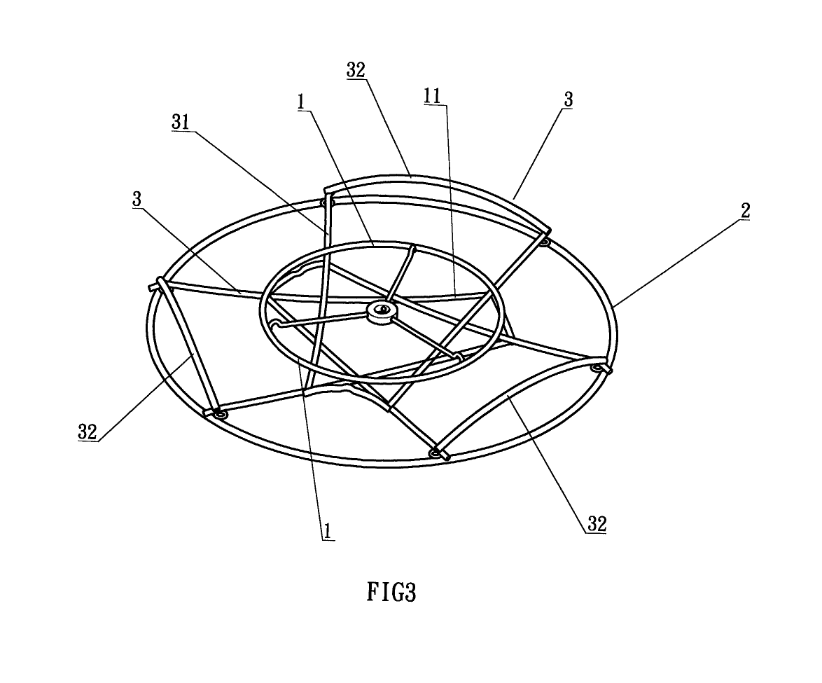

Referring to FIG. 3, the drawing depicting the invention herein in the folded state, when packaged, the frame members 3 must be first removed and laid flat such that lamp shade of the present invention occupies the smallest physical assembly space to facilitate ease of assembly and, furthermore, the resulting minimized storage area effectively reduces shipping costs.

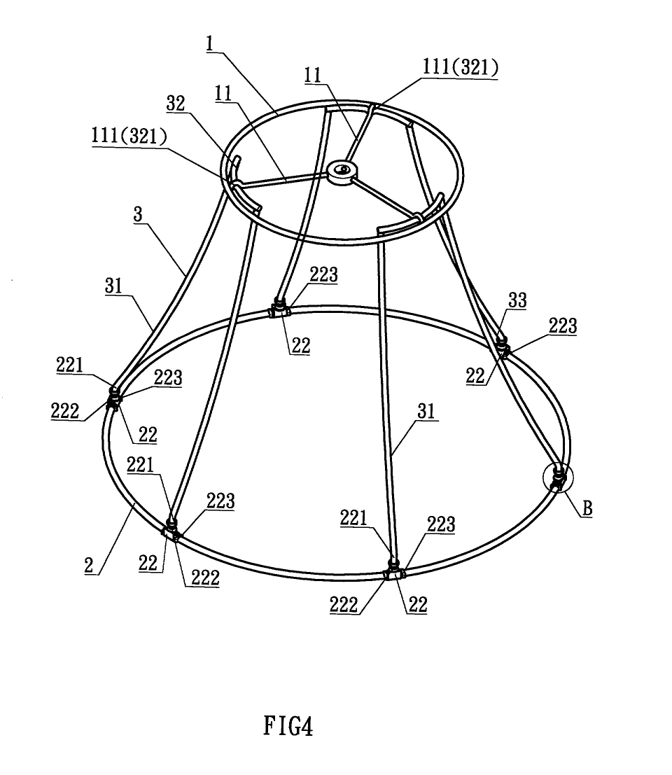

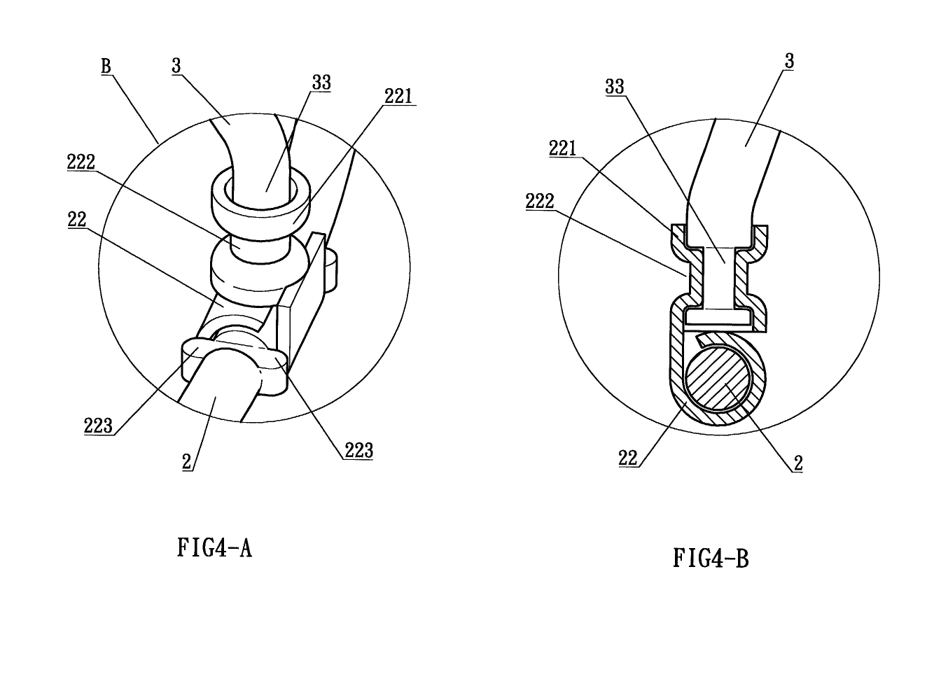

Referring to FIG. 4, the drawing of another embodiment of the invention herein, the said frame members 3 consist of left and right vertical curved rods 31 and coordinated upper and lower horizontal curved rods 32; the bottom ring 2 has respectively disposed at the support positions of the frame member 3 sleeve mounts 22, the sleeve mounts 22 each have projecting upward a keeper hole 221 that provides for the fixed insertion of the frame members 3 and, furthermore, after the frame member 3 insert posts 33 are slipped into the sleeve mounts 22, the sleeve mount 22 keeper holes 221 retain them by an integrated press-fit lock annulus 222; and furthermore, the two sides of the bottom ring 2 annular rod-like body to which each sleeve mount 22 is conjoined are punch flattened such that after punch flattening, the stop nubs 223 thereby formed position and limit the movement of the sleeve mounts 22.

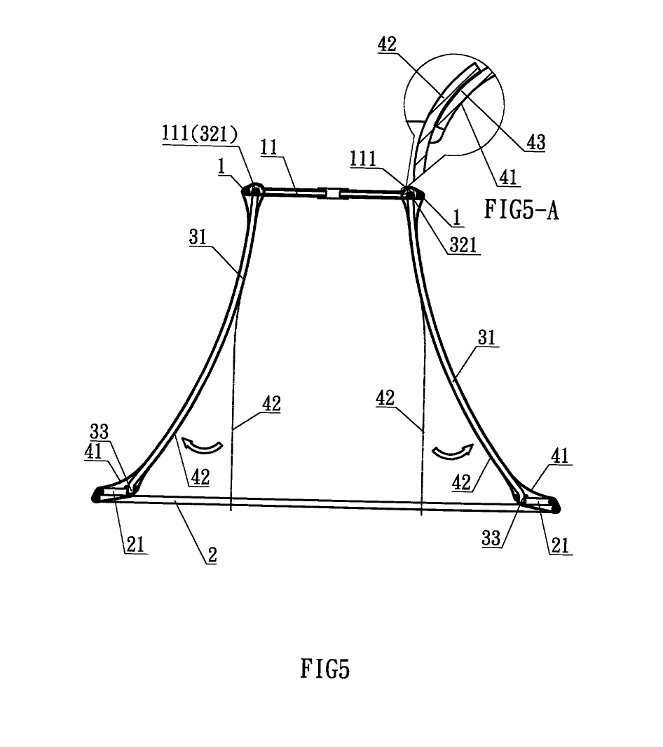

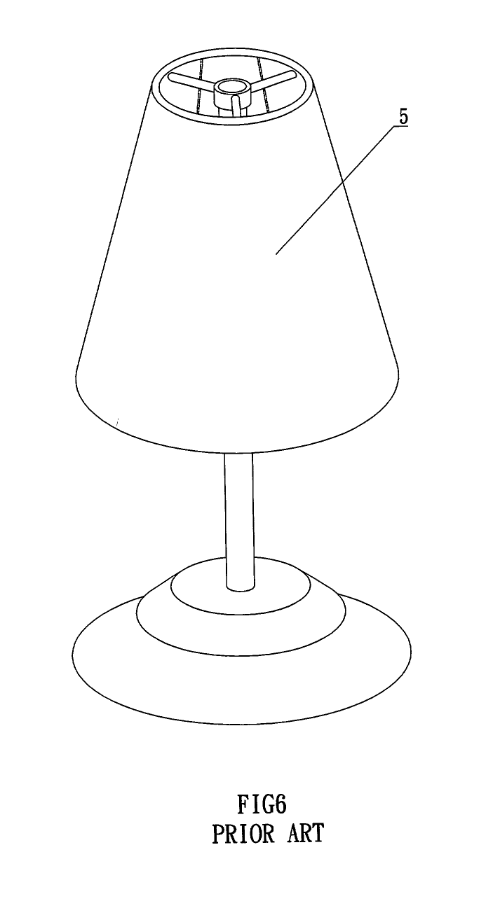

Referring to FIG. 5, after the assembly of the said lamp shade is completed, the top ring 1 and the bottom ring 2 are wrapped in an enshrouding fabric material lamp shade 4, wherein an exterior fabric surface layer 41 of the said lamp shade 4 is first tightly fitted onto the outer periphery of the frame members 3; additionally, an interior fabric surface layer 42 is placed along the inner sides of the frame members 3 and, furthermore, an adhesive fastening tape 43 is respectively applied over an appropriate area of the interior fabric surface layer 42 and the exterior fabric surface layer 41, the frame members 3 are enveloped within such that the frame members 3 remain unexposed due to the ensconcing structural arrangement constituted by the interior fabric surface layer 42 and the exterior fabric surface layer 41, while also effectively achieving an attractive appearance; and, when the frame is folded, the attached lamp shade 4 collapses along with it to achieve a reduction in material storage area and thereby effectively lower shipping costs.

In summation of the foregoing section, since the disassembly-type lamp shade structure of the invention herein is capable of achieving all of the claimed objectives, the present invention is lawfully submitted in application for review and the granting of the commensurate patent rights.

1. A disassembly-type lamp shade structure comprised of a top ring, a bottom ring situated at the uppermost end of a lamp shade, and frame members propped between the said top ring and the said bottom ring, the innovative features of which include:
The said top ring has support rods extending from the center towards its circumference and, furthermore, the said support rods each have at their extremities an upward bend to form an insertion hook that is fixed onto the circumference of the said top ring:
The said bottom ring has respectively disposed at the support positions of the said frame members sleeve mounts that provide for the insertion of the said frame members.
The said frame members consist of left and right vertical curved rods and coordinated upper and lower horizontal curved rods, with the degree of curvature of the said upper horizontal rods matching that of the said top ring and the degree of curvature of the said lower horizontal rods matching that of the said bottom ring, at the area of confluence between the said frame member upper horizontal curved rods and the said support rods, the said upper horizontal curved rods have formed by downward bending an indentation serving as a catch hook that secures the said insertion hook; the said frame member bottom ends are bent so they meet with the said bottom ring in a perpendicular arrangement and, furthermore, the insert posts thereby formed are capable of being slipped into the said bottom ring sleeve mounts such that after the said frame member insert posts are slipped into the said sleeve mounts, the said upper horizontal curved rods are situated against the said insertion hooks at the extremities of the said support rods and the said lower horizontal curved rods are situated against the said bottom ring.
As such, lamp shade of the present invention occupies the smallest physical assembly space to facilitate ease of assembly and, furthermore, the resulting minimized storage area effectively reduces shipping costs.

2. A disassembly-type lamp shade structure comprised of a top ring, a bottom ring situated at the uppermost end of a lamp shade, and frame members propped between the top ring and the bottom ring, the innovative features of which include:
The said top ring has support rods extending from the center towards its circumference and, furthermore, the said support rods each have at their extremities an upward bend to form an insertion hook that is fixed onto the circumference of the said top ring.
The said bottom ring has respectively disposed at the support positions of the said frame member sleeve mounts, the said sleeve mounts each have projecting upward a keeper hole that provides for the fixed insertion of the said frame members and, furthermore, after insert posts of said frame members are slipped into the said sleeve mounts, the said sleeve mount keeper holes retain them by an integrated press-fit lock annulus; and furthermore, the two sides of the said bottom ring annular rod-like body to which each said sleeve mount is conjoined are punch flattened such that after punch flattening, the stop nubs thereby formed position and limit the movement of the said sleeve mounts.
The said frame members consist of left and right vertical curved rods and coordinated upper and lower horizontal curved rods; at the area of confluence between the said frame member upper horizontal curved rods and the said support rods, the said upper horizontal curved rods have formed by downward bending an indentation serving as a catch hook; and the said frame member bottom ends are bent so they meet with the said bottom ring in a perpendicular arrangement and, furthermore, the said insert posts thereby formed are capable of being slipped into the said bottom ring sleeve mounts.
As such, lamp shade of the present invention occupies the smallest physical assembly space to facilitate ease of assembly and, furthermore, the resulting minimized storage area effectively reduces shipping costs.

3. As mentioned in claim 1 and claim 2 of the disassembly-type lamp shade structure invention herein, the said top ring and the said bottom ring are wrapped in an enshrouding fabric material lamp shade; an exterior fabric surface layer of the said lamp shade is first tightly fitted onto the outer periphery of the said frame members and an interior fabric surface layer is placed along the inner sides of the said frame members and, furthermore, an adhesive fastening tape is respectively applied over an appropriate area of the said interior fabric surface layer and the said exterior fabric surface layer, with the said interior fabric surface layer and the said exterior fabric surface layer forming an ensconcing structural arrangement that also effectively achieves an attractive appearance; and, when the frame of the present invention is folded, the attached said lamp shade collapses along with it to achieve a reduction in material storage area and thereby effectively lower shipping costs.
